(19) United States
(12) Patent Application Publication
(10) Pub. No.: US 2017/0304895 A1
(43) Pub. Date: Oct. 26, 2017

(54) ADDITIVE MANUFACTURING APPARATUS AND METHOD

(71) Applicant: RENISHAW PLC, Wotton-under-Edge, Gloucestershire (GB)

(72) Inventors: Adrian PORCH, Pontypridd (GB); Geoffrey MCFARLAND, Wickwar (GB)

(73) Assignee: RENISHAW PLC, Wotton-under-Edge, Gloucestershire (GB)

(21) Appl. No.: 15/514,149

(22) PCT Filed: Sep. 30, 2015
(86) PCT No.: PCT/GB2015/052842

§ 371 Date: Mar. 24, 2017

(30) Foreign Application Priority Data
Oct. 1, 2014 (GB) 1417363.7
Oct. 1, 2014 (GB) 1417364.5
Oct. 1, 2014 (GB) 1417383.5

(51) Int. Cl. B22F 3/105; B33Y 30/00; B33Y 50/02; B23K 26/342; B33Y 10/00

(52) U.S. Cl. CPC B22F 3/1055; B23K 26/342; B33Y 30/00; B33Y 10/00; B33Y 50/02; B22F 2003/1054; B22F 2003/1057

(57) ABSTRACT

An additive manufacturing apparatus including a build chamber containing a support for supporting a material bed, a layering device for forming layers of the material bed, a laser or electron beam source for generating a laser or electron beam, a device for steering the laser or electron beam to solidify selected areas of each layer to form a part and a microwave or radio wave source controllable to generate a microwave or radio wave field to differentially heat the material bed based upon the selected areas.

### FIELD OF THE INVENTION

This invention concerns an additive manufacturing apparatus and method. The invention has particular, but not exclusive application, to a selective laser melting (SLM) or selective laser sintering (SLS) system in which a powder bed is preheated before the powder bed is selectively melted or sintered.

### BACKGROUND

Selective laser melting (SLM) and selective laser sintering (SLS) apparatus produce objects through layer-by-layer solidification of a material, such as a metal powder material, using a high energy beam, such as a laser beam. A powder layer is formed across a powder bed in a build chamber by depositing a heap of powder adjacent to the powder bed and spreading the heap of powder with a wiper across (from one side to another side of) the powder bed to form the layer. A laser beam is then scanned across areas of the powder layer that correspond to a cross-section of the object being constructed. The laser beam melts or sinters the powder to form a solidified layer. After selective solidification of a layer, the powder bed is lowered by a thickness of the newly solidified layer and a further layer of powder is spread over the surface and solidified, as required. An example of such a device is disclosed in U.S. Pat. No. 6,042,774.

During the build, forces produced as the solidified material contracts during cooling can result in distortion of the part, such as curling of the part upwards. It is known to build supports as part of the build for holding the part in place. However, such supports can be difficult to remove at the end of the build. Furthermore, residual stresses in the part can cause the part to distort when the part is released from the supports.

When melting/sintering the powder material it is desirable to bring the powder to the sintering/melting temperature whilst vaporising as little of the material as possible. However, heating of the powder layer with the laser produces a decreasing temperature gradient throughout the layer thickness. Accordingly, to melt powder throughout the layer thickness may require upper parts of the layer to reach a temperature significantly above the sintering/melting temperature, potentially resulting in vaporisation (potentially, explosive vaporisation) of the powder. Vaporisation and, in particular, explosive vaporisation, can result in the formation of voids in the part. Furthermore, defects may be formed in the part from vaporised material solidifying at undesirable locations on the powder bed during part formation.

It is known to reduce the temperature gradients generated by the laser during part formation by heating the entire powder bed to a temperature close to the melting or sintering temperature before melting or sintering the powder with the laser. WO96/29192 discloses a heating coil located in an upper region of a boundary wall of the build chamber. EP1355760 discloses providing a heating plate on or integrated into a platform supporting the powder bed to heat the powder bed during part formation. US2009/0152771 discloses radiant heaters for heating up a newly applied powder layer.

US2012/0237745 A1 discloses apparatus in which a defocussed and homogenized energy beam is used to preheat a powder layer. The energy beam is applied continuously during the whole process of producing a ceramic or glass-ceramic article and provides the same amount of energy per time and area on the whole surface of a deposited layer. Preheating may be carried out by laser irradiation, electron irradiation or microwave irradiation, preferably laser irradiation.

Apparatus are known for varying the heat input to different regions of the bed. U.S. Pat. No. 6,815,636 discloses a zoned radiant heater to preheat the powder, wherein the heat input can be varied in either a radial or a circumferential direction. The zoned radiant heater is controlled to moderate the powder bed temperatures to minimise deviations from desired set point temperatures. US2008/0262659 discloses a heater tray including eight heaters for heating the powder bed. The heaters may be repositioned or adjusted on the heater tray to provide an even heat distribution to the powder bed. US2013/0309420 discloses a series of inductors for regulating a temperature of a metal powder bed. The inductors are fitted around the perimeter of the build plate and envelop the article being manufactured. On account of the many inductors present around the powder bed, the temperature of the powder may be regulated on a zone-by-zone basis.

In all these examples, for the melting of powder, the powder temperature may have to be elevated above the sintering temperature to significantly reduce the chance of vaporisation of the powder when melting the powder with a laser beam. However, elevating the powder above this temperature will cause the powder to sinter together and form a “part cake”. The sintering of the powder may prevent recycling of the unmelted powder for use in further builds.

U.S. Pat. No. 5,508,489 discloses a laser sintering system having a sintering beam having a focal point at the powder bed and at least one defocussed laser beam incident on the region near the focal point of the focussed beam. The defocussed beam raises the temperature of the material surrounding the sintering beam to a level below the sintering temperature, thereby reducing the temperature gradient between the sintering location and the surrounding material. U.S. Pat. No. 8,502,107 discloses a method of forming a product by freeform sintering and/or melting, in which a laser or electron beam irradiates predetermined positions a plurality of times. Each position is initially heated to a temperature below the melting point of the material and during a subsequent irradiation to a temperature above the melting temperature.

### SUMMARY OF INVENTION

According to a first aspect of the invention there is provided an additive manufacturing apparatus comprising a build chamber containing a support for supporting a material bed, a layering device for forming layers of the material bed, a laser or electron beam source for generating a laser or electron beam and a device for steering the laser or electron beam to solidify selected areas of each layer to form a part.

The apparatus may further comprise a microwave or radio wave source controllable to generate a microwave or radio wave field to differentially heat the material bed based upon the selected areas.

The microwave or radio wave source may be controllable to generate a microwave or radio wave field to selectively heat the material bed.

The invention according to the first aspect may allow the selected areas of each layer of the material bed, such as a powder bed or bath of thermosetting resin, to be preheated with microwaves or radio waves before solidification, such as by melting, sintering or curing, with the laser or electron beam. The microwave or radio wave field may be directed such that the selected areas are preheated to a higher temperature than other areas of the layer, which are not selected to be solidified. In particular, in the case of powder being solidified by melting, the selected areas may be preheated to or above the sintering temperature, whereas unselected areas may remain below the sintering temperature. The areas of the material bed heated to the higher temperature may encompass, but be slightly larger, than the corresponding selected area to be solidified. Microwave or radio wave sources are typically cheaper than laser sources used for solidifying the material layers and the energy of the microwaves or radio waves can be sufficiently directed to avoid overly heating areas of each material layer that are not to be solidified. Accordingly, the temperature of the areas to be solidified may be raised to avoid explosive vaporisation of the material when melted with the electron or laser beam whilst formation of large regions of the material bed into a part-cake may be avoided.

The apparatus may comprise a controller for controlling the microwave or radio wave source to steer the microwaves or radio waves to desired locations on the material bed.

The controller may be arranged for controlling the microwave or radio wave source to steer the microwaves or radio waves to heat selected portions of unsolidified material neighbouring solidified material to regulate conduction of heat during cooling of the solidified material.

In this way, the apparatus may control the cooling of the solidified material to reduce forces that occur during or after the build that could cause distortion of the part.

The microwave or radio wave source may be controlled to selectively heat the material bed before, in parallel with and/or after solidification of the selected areas of one or more of the layers with the laser or electron beam.

The controller may be arranged to control the microwave or radio wave source to selectively heat the unsolidified material in parallel with and/or after solidification of the selected areas of one or more of the layers with the laser or electron beam, for example to control the cooling of the solidified areas.

Microwaves or radio waves may heat the unsolidified material by heating the unsolidified material, such as powder, around the solidified material and/or a surface of the solidified material. Microwaves or radio waves may penetrate metal powder more effectively than laser, electron beam or ion beams, allowing the apparatus to regulate cooling of not just solidified material of the uppermost layer but a plurality of layers below the uppermost layer. Furthermore, the Faraday cage effect produced by solid metal bodies may prevent the microwaves or radio waves from penetrating hollow metal structures built during the build ensuring that powder within the hollow metal bodies of a part is not heated, for example above a sintering temperature. Accordingly, the heating of the powder with microwaves or radio waves may be confined to powder adjacent an outer surface of the solidified material of the part such that powder contained within the part can be easily removed at the end of the build.

The controller may be arranged to control the further radiation source to change a radiation pattern generated by the radiation source, a width (1/e² width) of a beam generated by the radiation source, a shape of the beam, an angle of the beam to the surface of the material bed, speed of the beam across the material bed, a point distance between points exposed to radiation generated by the radiation source and/or exposure time for each point. The changes may be made dependent on the selected portion of unsolidified material to be heated, for example the size and shape of the selected portion, laser or electron beam parameters being used to process the selected areas, a geometry of the part, layer thickness and/or a thermal model of heat dissipation during the build. The laser or electron beam parameters may be laser or electron beam power, scan speed of a laser or electron beam spot, point distance, exposure time, laser or electron beam spot size, laser or electron beam spot shape

The controller may be arranged to control the microwave or radio wave source to control a penetration depth of the microwaves or radio waves into the material bed. The controller may control the microwave or radio wave source to change a frequency of the microwaves or radio waves to alter the penetration depth.

The controller or radio wave source may be controlled to selectively heat the material bed before and/or in parallel with solidification of the selected areas of one or more of the layers with the laser or electron beam to preheat the selected areas before solidification.

The microwave or radio wave source may be controllable to change the microwave or radio wave field during solidification of selected areas of at least one or more of the layers. In particular, a first selected area may be preheated to a desired temperature using the microwaves or radio waves followed by a second selected area. The apparatus may be arranged to preheat the second selected area with the microwaves or radio waves whilst the first selected area is being solidified with the laser or electron beam.

The microwave or radio wave source may be controllable to change the microwave or radio wave field between layers as the selected areas to be solidified change from layer to layer.

The microwave or radio wave source may be controllable to generate differing microwave or radio wave patterns (on the material bed) during the build.

The microwave or radio wave source may comprise an array of microwave or radio wave emitters, such as an array of magnetrons, klystrons, travelling-wave tubes, gyrotrons or an antenna array. The array may be controllable for generating differing microwave or radio wave patterns dependent on selected areas to be heated. The array may act as a phased array, controllable such that the relative phase of the microwaves or radio waves generated by each emitter can be varied to change the microwave or radio wave pattern generated by the array. In this way, the array can be controlled to generate a microwave or radio wave pattern having one or more intensity peaks that coincide with the selected areas of the material layer to be heated with the microwaves or radio waves.

In an alternative embodiment, the microwave or radio wave source comprises a microwave or radio wave emitter and a movable reflector or lens, such as a parabolic reflector (for creating a spot), a cylindrical reflector (for creating a line) or microwave lens, for collecting the microwaves or radio waves emitted by the emitter and directing the microwaves or radio waves in a narrow beam to the material bed.

In a further embodiment, the microwave or radio wave source comprises microwave or radio wave emitter mounted on a gantry to be movable in two-dimension for directing the microwave or radio waves to the selected areas of the material bed. Alternatively, the microwave or radio wave source comprises microwave or radio wave emitter mounted on an articulating arm for moving the microwave or radio wave emitter to positions for directing the microwaves or radio waves to the selected areas of the material bed.

In a yet another embodiment, the microwave or radio wave source comprises at least one maser, for example, a solid-state maser, for generating a maser beam and a device for steering the maser beam to different locations on the material bed.

The laser or electron beam source may be used to solidify material whilst the, possibly less accurate, targeted microwave or radio wave source may be used to preheat the material. In this way, build times are increased without forming large volumes of the material bed into a part cake. Furthermore, the microwave or radio wave source may be a cheaper energy source than the laser or electron beam given possibly lower requirements in terms of power and accuracy.

According to a second aspect of the invention there is provided a method of manufacturing a part, in which material layers are solidified using a laser or electron beam in a layer-by-layer manner to form an object, the method comprising, repeatedly, forming a layer of a material bed and scanning the laser or electron beam across the layer to solidify selected areas of the layer.

The method may further comprise generating a microwave or radio wave field to differentially heat the material bed based upon the selected areas.

The method may further comprise generating a microwave or radio wave field to selectively heat the material bed

The method may further comprise preheating each one of the selected areas of each layer with the microwave or radio wave field whilst the laser or electron beam is solidifying a separate one of the selected areas.

The method may further comprise steering the microwaves or radio waves to heat selected portions of unsolidified material neighbouring solidified material to regulate conduction of heat through the solidified material during cooling.

The method may further comprise heating the material bed with one or more patterns of electromagnetic radiation generated using a phased array.

According to a third aspect of the invention there is provided a data carrier having instructions stored thereon, which when executed by a processor of an additive manufacturing apparatus according to the first aspect of the invention, causes a microwave or radio wave source to generate the microwave or radio wave field to differentially heat the material bed based upon the selected areas.

The instructions, when executed by a processor, may cause a microwave or radio wave source to generate the microwave or radio wave field to selectively heat the material bed.

The instructions, when executed by a processor, may cause the radiation source to selectively heat portions of unsolidified material neighbouring solidified material to regulate conduction of heat through the solidified material during cooling.

According to a fourth aspect of the invention there is provided a data carrier having instructions stored thereon, which when executed by a processor of an additive manufacturing apparatus according to the first aspect of the invention, causes the additive manufacturing apparatus to preheat each one of the selected areas of each layer with a further energy source whilst the laser or electron beam is solidifying a separate one of the selected areas.

According to a fifth aspect of the invention there is provided a data carrier having instructions stored thereon, which when executed by a processor of an additive manufacturing apparatus according to the first aspect of the invention, causes the additive manufacturing apparatus to heat the material bed with one or more patterns of electromagnetic radiation generated using a phased array.

The data carrier of the above aspects of the invention may be a suitable medium for providing a machine with instructions such as non-transient data carrier, for example a floppy disk, a CD ROM, a DVD ROM/RAM (including -R/-RW and +R/+RW), an HD DVD, a Blu Ray™ disc, a memory (such as a Memory Stick™, an SD card, a compact flash card, or the like), a disc drive (such as a hard disc drive), a tape, any magneto/optical storage, or a transient data carrier, such as a signal on a wire or fibre optic or a wireless signal, for example a signals sent over a wired or wireless network (such as an Internet download, an FTP transfer, or the like).

### DESCRIPTION OF THE DRAWINGS

FIG. 1 is a schematic representation of selective laser solidification apparatus according to an embodiment of the invention;

FIG. 2 is a schematic representation of the selective laser solidification apparatus shown in FIG. 1 viewed from a different angle;

FIG. 3 is a schematic representation of the selective laser solidification apparatus, shown in FIGS. 1 and 2, from above; and

FIG. 4 schematically represents a method according to an embodiment of the invention that can be carried out using the apparatus shown in FIGS. 1 to 3.

### DESCRIPTION OF EMBODIMENTS

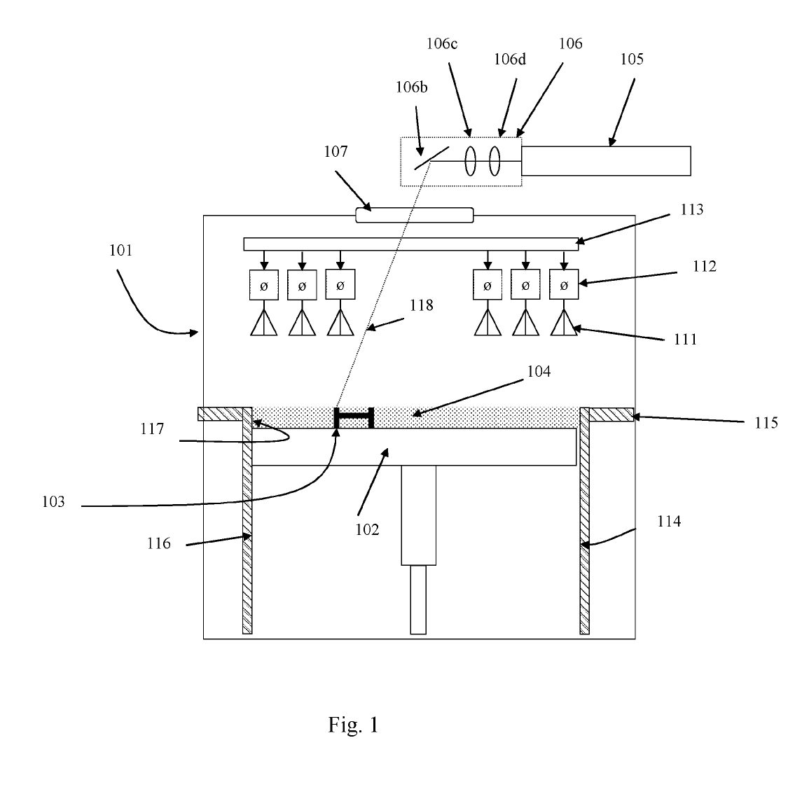

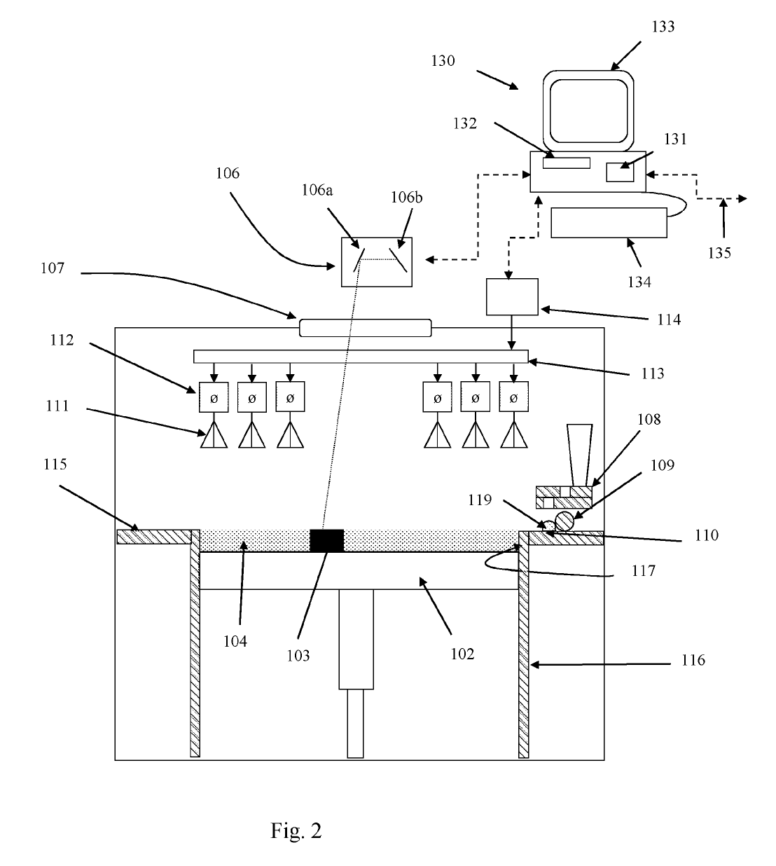

Referring to FIGS. 1 to 3, a laser solidification apparatus according to an embodiment of the invention comprises a main chamber 101 having therein partitions 115, 116, which define a build chamber 117 and a surface 110 onto which powder can be deposited. A build platform 102 is provided for supporting a powder bed 104 and an object/objects 103 built by selective laser melting powder 104. The platform 102 can be lowered within the build chamber 117 as successive layers of the object 103 are formed. A build volume available is defined by the extent to which the build platform 102 can be lowered into the build chamber 117.

The build progresses by successively depositing layers of powder across the powder bed 104 using dispensing apparatus 108 for dosing the powder onto surface 110 and an elongate wiper 109 for spreading the powder across the bed 104. For example, the dispensing apparatus 108 may be apparatus as described in WO2010/007396. The wiper 109 moves in a linear direction across the build platform 102.

A laser module 105 generates a laser for melting the powder 104, the laser directed as required by optical scanner 106 under the control of a computer 130. The laser enters the chamber 101 via a window 107. In this embodiment, the laser module 105 is a fibre laser, such as an nd:YAG fibre laser.

The optical scanner 106 comprises steering optics, in this embodiment, two movable mirrors 106a, 106b for directing the laser beam to the desired location on the powder bed 104 and focussing optics, in this embodiment a pair of movable lenses 106c, 106d, for adjusting a focal length of the laser beam. Motors (not shown) drive movement of the mirrors 106a and lenses 106b, 106c, the motors controlled by computer 130.

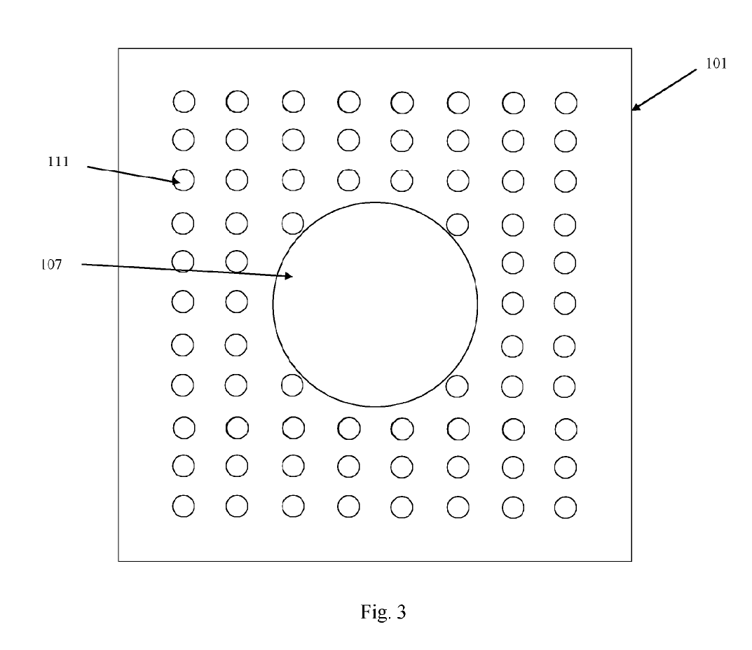

The apparatus further comprises a phased array comprising an array of antennas 111 for generating microwaves or radio waves. The antenna array is powered by power source 114. The power from source 114 is distributed to the antennas 111 by a power divider 113, which controls the amplitude of the power signal delivered to each antenna and phase shifters 112, which control the phase of the power signal sent to each antenna 111. The power source 114, power divider 113 and phase shifters 112 are controlled by computer 130. As shown in FIG. 3, the array of antennas 111 may discontinue around window 107 to provide space for the laser beam 118 to be delivered to the powder bed 104.

Computer 130 comprises the processor unit 131, memory 132, display 133, user input device 134, such as a keyboard, touch screen, etc, a data connection to modules of the laser melting unit, such as optical module 106, laser module 105, power source 114, power divider 113 and phase shifters 112, and an external data connection 135. Stored on memory 132 is a computer program that instructs the processing unit to carry out the method as now described.

In use, processor unit 131 receives, for example, via external connection 135 geometric data describing scan paths to take in solidifying areas of powder in each powder layer. To build a part, the processor unit 131 controls modules of the phased array (powder source 114, power divider 113 and phase shifters 112) to generate a microwave or radio wave field in the powder bed 104 that heats selected areas of the powder bed 104 to be solidified to a desired temperature, such as close to the melting point of the powder 104, whilst powder 104 in other areas of the powder bed 104 that are not to be solidified remain below this temperature, and preferably below the sintering temperature of the powder 104. The computer 130 can determine the areas to be heated to the desired temperature from the geometric data.

Simultaneously with heating the powder bed with the phased array, the computer 130 controls the scanner 106 to direct the laser beam 118 in accordance with the scan paths defined in the geometric data. In this embodiment, to perform a scan along a scan path, the laser 105 and scanner 106 are synchronised to expose a series of discrete points along the scan path to the laser beam. For each scan path, a point distance, point exposure time and spot size is defined. In an alternative embodiment, the spot may be continuously scanned along the scan path. In such an embodiment, rather than defining a point distance and exposure time, a velocity of the laser spot may be specified for each scan path.

The phased array may begin heating the powder 104 of a layer before the laser beam begins melting selected areas of the powder 104 to ensure the that the initial areas to be melted are raised to the desired temperature. The field pattern generated by the phased array may be changed during melting of the powder layer to increase the temperature of different areas of the powder layer synchronously with progression of the laser beam 118 along the scan paths. In particular, the field pattern may be changed to preheat selected areas to be melted to the desired temperature a short time before, such as immediately before, the areas are melted with the laser beam 118.

The areas of each powder layer heated to the desired temperature by the phased array may be slightly larger than the areas to be melted. Accordingly, this may result in a small amount of sintered powder that is not melted surrounding the part. At the end of the build, this sintered material can be removed from the part. Powder that is recovered after the build for use in subsequent builds may be sieved to remove clumps of sintered powder.

It is believed that by heating the powder to close to its melting point with the phased array, the selected areas of the powder can then be solidified using a lower power laser, such as a 5 to 10 Watt laser, than is necessary without preheating (typically a laser of at least 100 Watts is required). It may be possible to achieve better beam quality (M²) with lower power lasers and therefore, smaller spot sizes at the powder bed surface. As an alternative to a low power laser, the apparatus may comprise a high power laser that is divided into multiple low power laser beams for solidifying multiple ones of the selected areas at any one time. Such an apparatus may require multiple scanners 106, one for each laser beam.

In another embodiment, rather than a phased array, a directable microwave or radio wave may be provided by a maser and corresponding movable lenses/reflectors for steering the microwave or radio wave beam to the required locations on the powder bed. The movable reflector may be a polygon scanner for directing the beam in lines across the powder bed 104. The maser may be switched on and off as it is directed along each line based upon the location of the selected areas to be preheated.

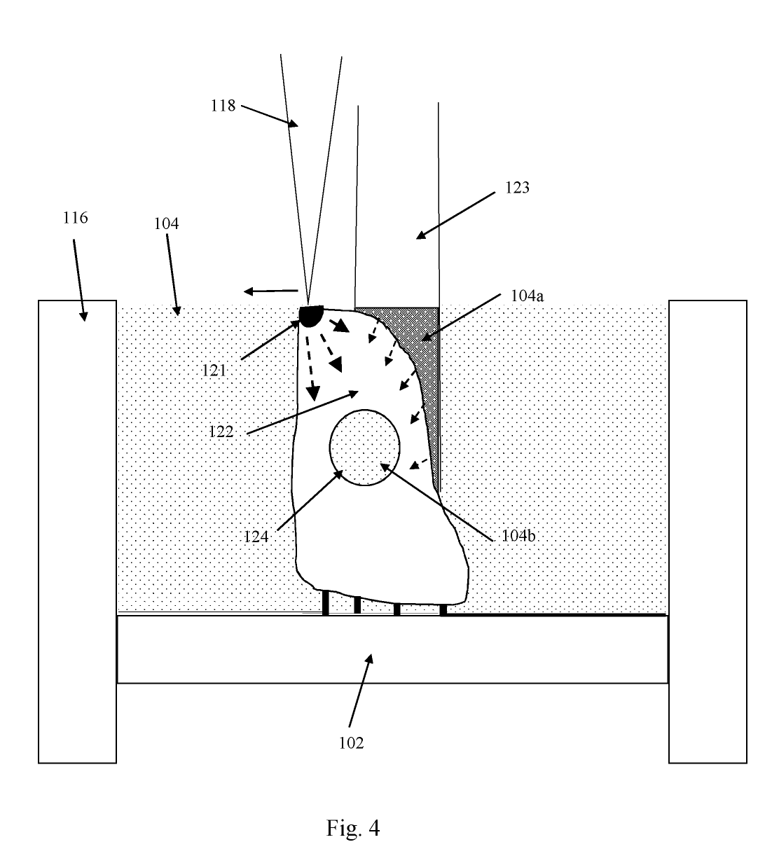

A further embodiment that may be carried out separately or in conjunction with the above described embodiment will now be described with reference to FIG. 4. As before, in use, processor unit 131 receives, for example, via external connection 135 geometric data describing scan paths to take in solidifying areas of powder in each powder layer. To build a part, the processor unit 131 controls the scanner 106 to direct the laser beam 118 in accordance with the scan paths defined in the geometric data to melt selected areas of the powder to form the part. Locally, the laser beam melts the powder to form a melt pool 121, which subsequently cools to form solidified material 122.

In this embodiment, to perform a scan along a scan path, the laser 105 and scanner 106 are synchronised to expose a series of discrete points along the scan path to the laser beam. For each scan path, a point distance, point exposure time and spot size is defined. In an alternative embodiment, the spot may be continuously scanned along the scan path. In such an embodiment, rather than defining a point distance and exposure time, a velocity of the laser spot may be specified for each scan path.

During scanning of selected areas of the powder layer with the laser beam 118, the processing unit 131 controls modules of the phased array (powder source 114, power divider 113 and phase shifters 112) to generate a microwave or radio wave beam 123 to selectively heat powder 104a surrounding selected portions of solidified material 122. The hot powder 104a around the solidified material 122 may alter a pattern of cooling of the solidified material 122, for example, by reducing a rate at which the solidified material 122/melt pool 121 cools by reducing temperature gradients through the solidified material and between the solidified material and the powder. The large and small dotted lines schematically indicate heat transfer away from the melt pool 121 as it cools and transfer of heat from the powder 104a, heated by the microwaves or radio waves, to the solidified material 122. Reducing the rate that portions of the solidified material 122 cool may reduce the rate of contraction that occurs when the solidified material 122 cools and therefore, the forces that may cause the part to distort. An acceptable rate at which solidified material cools may be dependent upon a geometry of the part and/or an orientation of the part during the build.

The microwaves or radio waves may penetrate deeper into the powder bed 104 than the laser beam 118 such that layers of the solidified material 122 below the layer of powder being melted by the laser beam are heated, reducing the rate of heat transfer downwards into the part as well as horizontally across the current layer being melted. Heating of powder 104a surrounding the part may result in sintering of this powder. However, the microwaves or radio waves will not penetrate into a solidified metal part beyond its surface. Accordingly, the microwaves or radio waves will not penetrate the part to heat powder material 104b located within cavities 124 of the solidified material and thus, this powder 104b will not be sintered (assuming that this powder 104b is not heated before the cavity is formed). Unsintered powder in the cavity can be easily removed at the end of the build. The cake of powder sintered to external surfaces of the part may be chipped off at the end of the build.

A penetration depth of the microwaves or radio waves into the powder may be controlled by altering the frequency of the microwaves or radio waves.

The portions of the solidified material 122 heated by the microwave/radio wave beam may be determined by modelling thermal changes in the part as the part is built.

In another embodiment, rather than a phased array a steerable microwave or radio wave may be provided by a maser and corresponding movable lenses/reflectors for steering the microwave or radio wave beam to the required locations on the powder bed. The movable reflector may be a polygon scanner for directing the beam in lines across the powder bed 104.

Alterations and modifications may be made to the embodiments as described hereinbefore without departing from the scope of the invention. Other non-microwave or radio wave sources may be used to preheat the powder that are directable to selected areas of the powder bed. For example, the a large multi-arm laser source, such as a CO₂ laser, one or more focussed IR sources, other electromagnetic radiation source or a plasma (ion) source.

1. An additive manufacturing apparatus comprising a build chamber containing a support for supporting a material bed, a layering device for forming layers of the material bed, a laser or electron beam source for generating a laser or electron beam, a device for steering the laser or electron beam to solidify selected areas of each layer to form a part and a microwave or radio wave source controllable to generate a microwave or radio wave field to differentially heat the material bed based upon the selected areas.

2. An additive manufacturing apparatus according to claim 1, wherein the microwave or radio wave source is controllable to generate a microwave or radio wave field to selectively heat the material bed.

3. An additive manufacturing apparatus according to claim 1, wherein the microwave or radio wave source is controllable to generate the microwave or radio wave field to preheat the selected areas of each layer before solidification with the laser or electron beam.

4. An additive manufacturing apparatus according to claim 3, wherein the microwave or radio wave source is controllable to generate the microwave or radio wave field to preheat the selected areas to a higher temperature than other areas of the layer, which are not selected to be solidified.

5. An additive manufacturing apparatus according to claim 4, wherein the microwave or radio wave source is controllable to generate the microwave or radio wave field to preheat the selected areas to or above the sintering temperature, whereas unselected areas remain below the sintering temperature.

6. An additive manufacturing apparatus according to claim 1, comprising a controller for controlling the microwave or radio wave source to steer the microwaves or radio waves to desired locations on the material bed.

7. An additive manufacturing apparatus according to claim 6, wherein the controller is arranged for controlling the microwave or radio wave source to steer the microwaves or radio waves to heat selected portions of unsolidified material neighbouring solidified material to regulate conduction of heat during cooling of the solidified material.

8. An additive manufacturing apparatus according to claim 1, wherein the laser or electron beam is steered to melt the selected areas of each layer.

9. An additive manufacturing apparatus according to claim 1, wherein the microwave or radio wave source is controlled to heat the material bed before, in parallel with and/or after solidification of the selected areas of one or more of the layers with the laser or electron beam.

10. An additive manufacturing apparatus according to claim 1, wherein the microwave or radio wave source is controllable to change the microwave or radio wave field during solidification of selected areas of one or more of the layers.

11. An additive manufacturing apparatus according to claim 10, wherein the microwave or radio wave source is controllable to preheat a first selected area of a layer to a desired temperature using the microwaves or radio waves followed by a second selected area of the layer.

12. An additive manufacturing apparatus according to claim 11, wherein the apparatus is arranged to preheat the second selected area with the microwaves or radio waves whilst the first selected area is being solidified with the laser or electron beam.

13. An additive manufacturing apparatus according to claim 1, wherein the microwave or radio wave source is controllable to change the microwave or radio wave field between layers as the selected areas to be solidified change from layer to layer.

14. An additive manufacturing apparatus according to claim 1, wherein the microwave or radio wave source comprises an array of microwave or radio wave emitters for generating the microwaves or radio waves.

15. An additive manufacturing apparatus according to claim 14, wherein the array is controllable such that the relative phase of the microwaves or radio waves generated by each emitter can be varied to change the microwave or radio wave field generated by the array.

16. An additive manufacturing apparatus according to claim 1, wherein the microwave or radio wave source comprises a microwave or radio wave emitter and a movable reflector or lens for collecting the microwaves or radio waves emitted by the emitter and directing the microwaves or radio waves in a narrow beam to the material bed.

17. An additive manufacturing apparatus according to claim 1, wherein the microwave or radio wave source comprises at least one maser for generating a maser beam and a device for steering the maser beam to the material bed.

18. A method of manufacturing a part, in which material layers are solidified using a laser or electron beam in a layer-by-layer manner to form an object, the method comprising, repeatedly, forming a layer of a material bed, and scanning the laser or electron beam across the layer to solidify selected areas of the layer, the method further comprising generating a microwave or radio wave field to differentially heat the material bed based upon the selected areas.

19. A data carrier having instructions stored thereon, which when executed by a processor of an additive manufacturing apparatus according to claim 1, causes the additive manufacturing apparatus to generate the microwave or radio wave field to differentially heat the material bed based upon the selected areas.

20. An additive manufacturing apparatus comprising a build chamber containing a support for supporting a material bed, a layering device for forming layers of the material bed, a laser or electron beam source for generating a laser or electron beam, a device for steering the laser or electron beam to solidify selected areas of each layer to form a part and a further energy source controllable to preheat each one of the selected areas of each layer whilst the laser or electron beam is solidifying a separate one of the selected areas.

21. A method of manufacturing a part, in which material layers are solidified using a laser or electron beam in a layer-by-layer manner to form an object, the method comprising, repeatedly, forming a layer of a material bed, and scanning the laser or electron beam across the layer to solidify selected areas of the layer, the method further comprising preheating each one of the selected areas of each layer with an energy source separate from the laser or electron beam whilst the laser or electron beam is solidifying a separate one of the selected areas.

22. A data carrier having instructions stored thereon, which when executed by a processor of an additive manufacturing apparatus according to claim 21 causes the additive manufacturing apparatus to preheat each one of the selected areas of each layer with the energy source whilst the laser or electron beam is solidifying a separate one of the selected areas.

23. An additive manufacturing apparatus comprising a build chamber containing a support for supporting a material bed, a layering device for forming layers of the material bed, a laser or electron beam source for generating a laser or electron beam, a device for steering the laser or electron beam to solidify selected areas of each layer to form a part and a phased array controllable to generate a pattern or patterns of electromagnetic radiation to heat the material bed.

24. A method of manufacturing a part, in which material layers are solidified using a laser or electron beam in a layer-by-layer manner to form an object, the method comprising, repeatedly, forming a layer of a material bed, and scanning the laser or electron beam across the layer to solidify selected areas of the layer, the method further comprising heating the material bed with one or more patterns of electromagnetic radiation generated using a phased array.

25. A data carrier having instructions stored thereon, which when executed by a processor of an additive manufacturing apparatus according to claim 24 causes the additive manufacturing apparatus to heat the material bed with one or more patterns of electromagnetic radiation generated using a phased array.

26. An additive manufacturing apparatus comprising a build chamber containing a support for supporting a material bed, a layering device for forming layers of material to form the material bed, a laser or electron beam source for generating a laser or electron beam, a device for steering the laser or electron beam to solidify selected areas of each layer to form solidified material of a part and a microwave or radio wave source to generate microwaves or radio waves steerable to a plurality of locations on the material bed and a controller for controlling the microwave or radio wave source to steer the radiation to heat selected portions of unsolidified material neighbouring the solidified material to regulate conduction of heat through the solidified material during cooling.
